(19) United States
(12) Patent Application Publication
(10) Pub. No.: US 2023/0410433 A1
(43) Pub. Date: Dec. 21, 2023

(54) NAVIGATION MESH UPDATE

(71) Applicant: Tencent Technology (Shenzhen) Company Limited, Shenzhen (CN)

(72) Inventors: Pengyu QIN, Shenzhen (CN); Zhenzhen FANG, Shenzhen (CN); Yikai LIN, Shenzhen (CN)

(73) Assignee: Tencent Technology (Shenzhen) Company Limited, Shenzhen (CN)

(21) Appl. No.: 18/239,683

(22) Filed: Aug. 29, 2023

Related U.S. Application Data
(63) Continuation of application No. PCT/CN2022/133124, filed on Nov. 21, 2022.

(30) Foreign Application Priority Data
Feb. 15, 2022 (CN) 202210135191.7

(51) Int. Cl. G06T 19/00; G06T 17/20; G06T 7/11

(52) U.S. Cl. CPC G06T 19/003; G06T 17/20; G06T 7/11

(57) ABSTRACT

In a navigation mesh update method, a to-be-updated region that includes a scene change in a virtual scene is determined. The to-be-updated region is one of a plurality of regions in the virtual scene. A physical model of a virtual object in the to-be-updated region is obtained. To-be-processed mesh data of the physical model is generated based on geometric data of the physical model in the to-be-updated region. A target navigation mesh is generated based on the to-be-processed mesh data of the physical model in the to-be-updated region. The target navigation mesh indicates a passable route in the to-be-updated region. A to-be-updated navigation mesh corresponding to the to-be-updated region of the plurality of regions in the virtual scene is updated with the target navigation mesh.

### RELATED APPLICATIONS

The present application is a continuation of International Application No. PCT/CN2022/133124 filed on Nov. 21, 2022, which claims priority to Chinese Patent Application No. 202210135191.7 filed on Feb. 15, 2022. The entire disclosures of the prior applications are hereby incorporated herein by reference.

### FIELD OF THE TECHNOLOGY

This disclosure relates to information processing technologies in the field of computer application, including to a navigation mesh update method and apparatus, an electronic device, a computer-readable storage medium, and a computer program product.

### BACKGROUND OF THE DISCLOSURE

A navigation mesh is a navigation route in a virtual scene, which is used for determining a passable route in the virtual scene. Generally, the navigation mesh is pre-generated scene. In other words, during the rendering of the virtual scene, the navigation mesh is static, which increases the update complexity of the navigation mesh, and consequently affecting the update efficiency of the navigation mesh.

### SUMMARY

Embodiments of this disclosure provide a navigation mesh update method and apparatus, an electronic device, a computer-readable storage medium, and a computer program product, which can improve the update efficiency of a navigation mesh.

The technical solutions of the embodiments of this disclosure can be implemented as follows:

An embodiment of this disclosure provides a navigation mesh update method. The method can be performed by an electronic device in an example. In the navigation mesh update method, a to-be-updated region that includes a scene change in a virtual scene is determined. The to-be-updated region is one of a plurality of regions in the virtual scene. A physical model of a virtual object in the to-be-updated region is obtained. To-be-processed mesh data of the physical model is generated based on geometric data of the physical model in the to-be-updated region. A target navigation mesh is generated based on the to-be-processed mesh data of the physical model in the to-be-updated region. The target navigation mesh indicates a passable route in the to-be-updated region. A to-be-updated navigation mesh corresponding to the to-be-updated region of the plurality of regions in the virtual scene is updated with the target navigation mesh.

An embodiment of this disclosure provides an information processing apparatus. The information processing apparatus includes a navigation mesh update apparatus in an example. The information processing apparatus includes processing circuitry that is configured to obtain a physical model of a virtual object in the to-be-updated region. The processing circuitry is configured to generate to-be-processed mesh data of the physical model based on geometric data of the physical model in the to-be-updated region. The processing circuitry is configured to generate a target navigation mesh based on the to-be-processed mesh data of the physical model in the to-be-updated region, the target navigation mesh indicating a passable route in the to-be-updated region. Further, the processing circuitry is configured to update a to-be-updated navigation mesh corresponding to the to-be-updated region of the plurality of regions in the virtual scene with the target navigation mesh.

An embodiment of this disclosure provides an electronic device for navigation mesh update, including a memory and a processor. The memory is configured to store computer executable instructions. The processor is configured to implement the navigation mesh update method provided in the embodiments of this disclosure when executing the computer executable instructions stored in the memory.

An embodiment of this disclosure provides a non-transitory computer-readable storage medium, storing computer executable instructions which when executed by a processor, cause the processor to perform the navigation mesh update method provided in the embodiments of this disclosure.

An embodiment of this disclosure provides a computer program product, including a computer program or computer executable instructions, the computer program or computer executable instructions, when executed by a processor, implementing the navigation mesh update method provided in the embodiments of this disclosure.

The embodiments of this disclosure can have at least the following beneficial effects: When a virtual scene has a scene change, by detecting a physical model in a to-be-updated region, and re-determining a target navigation mesh corresponding to the to-be-updated region based on the physical model in the to-be-updated region, a navigation mesh can be updated in real time based on the scene change in a rendering process of the virtual scene. That is, update of the navigation mesh can be implemented based on the physical model in the to-be-updated region. Therefore, the update complexity of the navigation mesh can be reduced and the update efficiency of the navigation mesh can be improved.

### BRIEF DESCRIPTION OF THE DRAWINGS

FIG. 1 is a schematic architectural diagram of a navigation mesh update system according to an embodiment of this disclosure.

FIG. 2 is a schematic structural diagram of composition of a server in FIG. 1 according to an embodiment of this disclosure.

FIG. 3 is a schematic flowchart 1 of a navigation mesh update method according to an embodiment of this disclosure.

FIG. 4 is a schematic flowchart 2 of a navigation mesh update method according to an embodiment of this disclosure.

FIG. 5a is a schematic flowchart 3 of a navigation mesh update method according to an embodiment of this disclosure.

FIG. 5b is a flowchart of acquiring a target to-be-updated unit space according to an embodiment of this disclosure.

FIG. 5c is a flowchart 1 of acquiring to-be-processed mesh data according to an embodiment of this disclosure.

FIG. 5d is a flowchart 2 of acquiring to-be-processed mesh data according to an embodiment of this disclosure.

FIG. 5e is a flowchart of acquiring a target navigation mesh according to an embodiment of this disclosure.

FIG. 6 is a schematic flowchart 4 of a navigation mesh update method according to an embodiment of this disclosure.

FIG. 7 is a schematic flowchart of an exemplary navigation mesh update method according to an embodiment of this disclosure.

FIG. 8 is a schematic diagram of an exemplary game scene according to an embodiment of this disclosure.

FIG. 9 is a schematic diagram of another exemplary game scene according to an embodiment of this disclosure.

FIG. 10 is a schematic flowchart of an exemplary navigation mesh update method according to an embodiment of this disclosure.

FIG. 11 is a schematic diagram of exemplary geometrization processing according to an embodiment of this disclosure.

FIG. 12 is an exemplary process of performing triangle cutting on a convex polygon according to an embodiment of this disclosure.

FIG. 13 is a schematic diagram of exemplary route finding according to an embodiment of this disclosure.

### DESCRIPTION OF EMBODIMENTS

To make the objectives, technical solutions, and advantages of this disclosure clearer, the following describes this disclosure in further detail with reference to the accompanying drawings. The described embodiments are not to be considered as a limitation to this disclosure. Other embodiments shall fall within the protection scope of this disclosure.

In the following descriptions, related “some embodiments” describe a subset of all possible embodiments. However, it may be understood that the “some embodiments” may be the same subset or different subsets of all the possible embodiments, and may be combined with each other without conflict.

In the following descriptions, the included term “first/second/third” is merely intended to distinguish similar objects but does not indicate a specific order of an object. It may be understood that “first/second/third” is interchangeable in terms of a specific order or sequence if permitted, so that the embodiments of this disclosure described herein can be implemented in a sequence in addition to the sequence shown or described herein.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used in the embodiments of this disclosure are the same as those usually understood by a person skilled in the art to which this disclosure belongs. Terms used in the embodiments of this disclosure are merely intended to describe the embodiments of this disclosure, but are not intended to limit this disclosure.

Before the embodiments of this disclosure are further described in detail, nouns and terms involved in the embodiments of this disclosure are described. The nouns and terms provided in the embodiments of this disclosure are applicable to the following explanations.

1) Virtual scene may include a virtual scene displayed (or provided) when an application is running on a terminal device, or a virtual scene played by receiving audio and video information sent by a cloud server, where the application is running on the cloud server. In addition, the virtual scene may be a simulated environment of a real world, or may be a semi-simulated semi-fictional virtual environment, or may be an entirely fictional virtual environment; and the virtual scene may be any one of a two-dimensional virtual scene, a 2.5-dimensional virtual scene, or a three-dimensional virtual scene, and the dimension of the virtual scene is not limited in the embodiments of this disclosure. For example, the virtual scene may include the virtual sky, the virtual land, and the virtual ocean. The virtual land may include environmental elements such as the virtual desert and a virtual city. The user may control the virtual object to move in the virtual scene, and an intelligent agent (for example, a computer controlled virtual object) may also move in the virtual scene based on control information.

2) Physics engine may be configured to realize physical simulation calculation. Through the physics engine, virtual objects in the virtual scene are enabled to move according to physical parameters, so that the virtual objects can simulate the laws of motion in the real world for motion. In the embodiments of this disclosure, a detected physical model may be processed through the physics engine, to obtain a target navigation mesh.

3) Navigation mesh may include a walking surface, such as polygonal mesh data used for navigation, route finding, and marking walkable routes in complex spaces, which is also used for identifying the terrain of a location, and an action (for example, walking, swimming, or climbing) corresponding to a virtual character at a location. The navigation mesh may include a plurality of convex polygons, and each convex polygon is a basic unit of the navigation mesh, and is also a unit of route finding based on the navigation mesh. Two points in the same convex polygon of the navigation mesh may be reached in a straight line in a case of ignoring the terrain height. If the two points are located at different convex polygons, a to-be-passed convex polygon is calculated by using the navigation mesh and a route finding algorithm, and then a passable route is calculated based on the to-be-passed convex polygon.

4) Virtual objects may include images of various virtual humans and virtual things that can perform interaction in the virtual scene, or movable virtual objects in the virtual scene. The movable virtual objects may be virtual characters, virtual animals, cartoon characters, and the like, for example, virtual characters and virtual animals displayed in the virtual scene. The virtual object may be a virtual image used for representing a user in the virtual scene. The virtual scene may include a plurality of virtual objects, and each virtual object has a shape and a volume in the virtual scene, and occupies some space in the virtual scene.

5) Bounding box may be used for acquiring the optimal enclosing space of a discrete point set. For example, a geometry that is slightly larger than a target object in volume (greater than a volume threshold) and has simple characteristics (for example, the quantity of edges is smaller than the quantity of specified edges) is used to approximately replace the target object, where the geometry that is slightly larger than the target object in volume and has simple characteristics is a bounding box. Common bounding boxes include an axis-aligned bounding box (AABB), a bounding sphere, an oriented bounding box (OBB), and a fixed direction hull (FDH).

6) Scene data may represent feature data of the virtual scene. For example, it may be an area of a construction region in the virtual scene, and the current architectural style of the virtual scene; it may also include a position of a virtual building in the virtual scene, and an occupied area of the virtual building; and it may also be interaction data in the virtual scene, for example, an attack situation.

7) Client may include an application running on a device and configured to provide various services, for example, a game client, or a simulation client.

8) Cloud computing may include a computing mode, in which computing tasks are distributed on a resource pool formed by a large quantity of computers, so that various application systems can acquire computing power, storage space, and information services according to requirements. A network that provides resources to the resource pool is referred to as a “cloud”, and for a user, the resources in the “cloud” seem to be infinitely expandable, and can be acquired readily, used on demand, expanded readily, and paid according to use.

9) Cloud gaming may also be referred to as gaming on demand, and is an online gaming technology based on the cloud computing technology. The cloud gaming technology enables thin clients with graphics processing and data computing capabilities weaker than specified capabilities to play games smoothly. In a cloud game scene, the game is not run on a game terminal of a player, but in a cloud server, and the cloud server renders a game scene into audio/video streams, to transmit the audio/video streams to the game terminal of the player through a network. Even if graphics computing and data processing capabilities of the game terminal of the player are weaker than specified capabilities, the game terminal of the player can run a game through the basic streaming media playback capability and the capability to acquire player input instructions and transmit the player input instructions to the cloud server. The navigation mesh update method provided in the embodiments of this disclosure may be applied to cloud game applications.

10) Artificial Intelligence (AI), includes for example a theory, method, technology, and application system that uses a machine controlled by the digital computer to simulate, extend, and expand human intelligence, perceive an environment, acquire knowledge, and use knowledge to obtain an optimal result. In the embodiments of this disclosure, a to-be-moved virtual object may be an intelligent agent determined or controlled through AI.

A navigation mesh includes, for example, a navigation route in a virtual scene, which is used for determining a passable route in the virtual scene. Generally, a device for rendering a virtual scene does not include a game engine, but the game engine pre-generates the navigation mesh, uses the navigation mesh as a rendering resource, and performs route finding based on the navigation mesh in the rendering process of the virtual scene. However, the foregoing navigation mesh is static, and when the virtual scene changes, the navigation mesh cannot be updated based on the change of the virtual scene, resulting in relatively low navigation accuracy during movement based on the navigation mesh in the virtual scene.

In addition, update of the navigation mesh can be implemented through the game engine, but accessing the game engine will bring additional architecture restructuring, migration costs, and performance hidden dangers, which increases the resource consumption of the navigation mesh.

Based on this, embodiments of this disclosure provide a navigation mesh update method and apparatus, an electronic device, a computer-readable storage medium, and a computer program product, which can improve the navigation accuracy, simplify the system architecture of virtual scene rendering, reduce migration costs and performance hidden dangers, and improve the update efficiency of a navigation mesh. The following describes exemplary applications of an electronic device for navigation mesh update (which is referred to as an update device for short) provided in the embodiments of this disclosure. The update device provided in the embodiments of this disclosure may be implemented as various types of terminals such as a smart phone, a smart watch, a notebook computer, a tablet computer, a desktop computer, a smart home appliance, a set-top box, a smart in-vehicle device, a portable music player, a personal digital assistant, a dedicated messaging device, a smart voice interactive device, a portable game device, and a smart speaker, or may be implemented as a server. An exemplary application when the update device is implemented as a server will be described below.

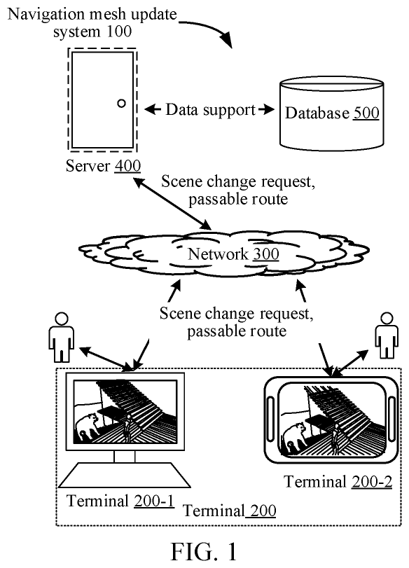

FIG. 1 is a schematic architectural diagram of a navigation mesh update system according to an embodiment of this disclosure. as shown in FIG. 1, to support a navigation mesh update application, in a navigation mesh update system 100, a terminal 200 (where a terminal 200-1 and a terminal 200-2 are shown as an example) is connected to a server 400 (which is referred to as an update device) through a network 300. The network 300 may be a wide area network, a local area network, or a combination thereof. In addition, the navigation mesh update system 100 further includes a database 500, configured to provide data support to the server 400. Besides, FIG. 1 shows a situation in which the database 500 is independent of the server 400. In addition, the database 500 may alternatively be integrated in the server 400, which is not limited in the embodiments of this disclosure.

The terminal 200 is configured to send a scene change request to the server 400 through the network 300 in response to a scene change operation; and is further configured to: receive, through the network 300, a passable route sent by the server 400 in response to the scene change request, and render a motion trajectory of the intelligent agent based on the passable route.

The server 400 is configured to: receive, through the network 300, the scene change request sent by the terminal 200, and in response to the scene change request, acquire a to-be-updated region that has a scene change in the virtual scene; perform model detection in the to-be-updated region, to obtain a physical model; perform geometrization processing on the physical model to obtain to-be-processed mesh data in a specified geometric shape; perform navigation processing on the to-be-processed mesh data to obtain a target navigation mesh, the target navigation mesh being used for determining a passable route in the to-be-updated region, and the specified geometric shape being a geometric shape corresponding to the navigation processing; update a to-be-updated navigation mesh corresponding to the to-be-updated region to the target navigation mesh, where the to-be-updated navigation mesh is an original navigation mesh corresponding to the to-be-updated region; and determine the passable route based on the target navigation mesh. The server 400 is further configured to send the passable route to the terminal 200 through the network 300.

In some embodiments, the server 400 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal 200 may be a smart phone, a smart watch, a notebook computer, a tablet computer, a desktop computer, a smart television, a set-top box, a smart in-vehicle device, a portable music player, a personal digital assistant, a dedicated messaging device, a portable game device, a smart speaker, or the like, but is not limited thereto. The terminal and the server may be directly or indirectly connected in a wired or wireless communication manner. This is not limited in the embodiments of this disclosure.

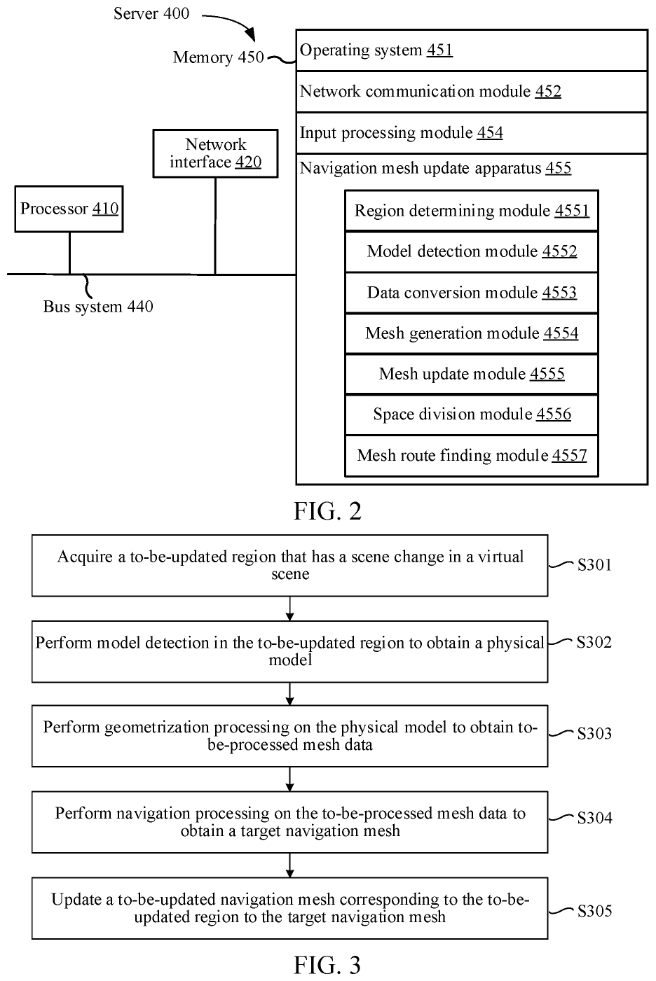

FIG. 2 is a schematic structural diagram of composition of a server in FIG. 1 according to an embodiment of this disclosure. The server 400 shown in FIG. 2 includes at least one processor 410, a memory 450, and at least one network interface 420. Components in the server 400 are coupled together by using a bus system 440. It may be understood that the bus system 440 is configured to implement connection and communication between the components. In addition to a data bus, the bus system 440 further includes a power bus, a control bus, and a status signal bus. However, for ease of clear description, all types of buses are marked as the bus system 440 in FIG. 2.

The processor 410 may be an integrated circuit chip having a signal processing capability, for example, processing circuitry such as a general purpose processor, a digital signal processor (DSP), or another programmable logic device (PLD), discrete gate, transistor logical device, or discrete hardware component. The general purpose processor may be a microprocessor, any conventional processor, or the like.

The memory 450 may be a removable memory, a non-removable memory, or a combination thereof. Exemplary hardware devices include a solid-state memory, a hard disk drive, an optical disc driver, or the like. The memory 450 optionally includes one or more storage devices that are physically away from the processor 410.

The memory 450 includes a volatile memory or a non-volatile memory, or may include both a volatile memory and a non-volatile memory. The non-volatile memory may be a read-only memory (ROM). The volatile memory may be a random access memory (RAM). The memory 450 described in this embodiment of this disclosure is to include any suitable type of memories.

In some embodiments, the memory 450 can store data to support various operations. Examples of the data include a program, a module, and a data structure, or a subset or a superset thereof, which are described below by using examples.

An operating system 451 includes a system program configured to process various basic system services and perform a hardware-related task, for example, a framework layer, a core library layer, and a driver layer, and is configured to implement various basic services and process a hardware-related task.

A network communication module 452 is configured to reach another electronic device through one or more (wired or wireless) network interfaces 420. Exemplary network interfaces 420 include: Bluetooth, WiFi, a universal serial bus (USB), and the like.

An input processing module 454 is configured to detect one or more user inputs or interactions from one of the one or more input apparatuses and translate the detected input or interaction.

In some embodiments, the navigation mesh update apparatus provided in the embodiments of this disclosure may be implemented by using software. FIG. 2 shows a navigation mesh update apparatus 455 stored in the memory 450. The apparatus may be software in a form such as a program and a plug-in, and includes the following software modules: a region determining module 4551, a model detection module 4552, a data conversion module 4553, a mesh generation module 4554, a mesh update module 4555, a space division module 4556, and a mesh route finding module 4557. These modules are logical modules, and may be combined in various manners or further divided based on a function to be performed. The following describes functions of the modules.

In some embodiments, the navigation mesh update apparatus provided in the embodiments of this disclosure may be implemented by using hardware. For example, the navigation mesh update apparatus provided in the embodiments of this disclosure may be processing circuitry, such as a processor, in a form of a hardware decoding processor, programmed to perform the navigation mesh update method provided in the embodiments of this disclosure. For example, the processor in the form of a hardware decoding processor may use one or more application-specific integrated circuits (ASIC), a DSP, a programmable logic device (PLD), a complex programmable logic device (CPLD), a field-programmable gate array (FPGA), or other electronic components.

In some embodiments, the terminal or the server may implement the navigation mesh update method provided in the embodiments of this disclosure by running a computer program. For example, the computer program may be a native program or software module in the operating system, may be a native application (APP), that is, a program that needs to be installed in the operating system to run, for example, a game APP, or may be an applet, that is, a program that only needs to be downloaded into a browser environment to run, and may alternatively be an applet that can be embedded into any APP. In summary, the computer program may be an application, a module, or a plug-in in any form.

The navigation mesh update method provided in the embodiments of this disclosure is described below with reference to the exemplary application and implementation of the update device provided in the embodiments of this disclosure. In addition, the navigation mesh update method provided in the embodiments of this disclosure is applied to various scenarios such as cloud technology, artificial intelligence, smart transportation, and vehicles.

FIG. 3 is a schematic flowchart 1 of a navigation mesh update method according to an embodiment of this disclosure. The navigation mesh update method is performed by an update device, and will be described with reference to the steps shown in FIG. 3.

S301: Acquire a to-be-updated region that has a scene change in a virtual scene. In an example, a to-be-updated region that includes a scene change in a virtual scene is determined, the to-be-updated region being one of a plurality of regions in the virtual scene.

In the embodiments of this disclosure, in a case that a virtual scene is presented, the update device detects a behavior of changing the virtual scene in the virtual scene in real time; and when the update device detects the behavior of changing the virtual scene, it is determined that the virtual scene has a scene change. Therefore, by acquiring a region that has the scene change in the virtual scene, a to-be-updated region is also obtained.

The update device detects the behavior of changing the virtual scene in the virtual scene by acquiring behavior data of changing the virtual scene in the virtual scene. The behavior data of changing the virtual scene includes at least one of construction behavior data of the virtual scene, destruction behavior data of the virtual scene, and movement behavior data of a virtual prop (for example, a virtual vehicle) in the virtual scene; and the behavior data of changing the virtual scene may be obtained by receiving an operation for changing the virtual scene, obtained by receiving an instruction used for instructing to change the virtual scene, obtained by event triggering, or the like, which is not limited in the embodiments of this disclosure. In addition, the to-be-updated region may be all regions that have a scene change in the virtual scene, some regions that have a scene change in the virtual scene, or the like, which is not limited in the embodiments of this disclosure; and when the to-be-updated region is some regions that have a scene change in the virtual scene, the some regions that have a scene change may be the region with the highest priority among all the regions that have a scene change.

S302: Perform model detection in the to-be-updated region to obtain a physical model. In an example, a physical model of a virtual object in the to-be-updated region is obtained.

In the embodiments of this disclosure, after obtaining the to-be-updated region, the update device performs model detection in the to-be-updated region. The detected model is referred to as a physical model, and the physical model is configured to regenerate a navigation mesh in the to-be-updated region. The physical model refers to a virtual object in the to-be-updated region, for example, a rigid body model such as a virtual building or a virtual character. The rigid body model herein refers to an object model that a shape and a size remain unchanged during motion or after a force is applied, and the relative positions of points inside are unchanged.

Because the scene change occurs in the to-be-updated region due to a change of the physical model in the to-be-updated region, and the changed physical model is a factor that affects the change of the navigation mesh in the to-be-updated region, the update device detects the physical model in the to-be-updated region, to update the navigation mesh in the to-be-updated region according to the detected physical model, thereby implementing the update of the navigation mesh adapted to the scene change, and improving the degree of matching between the navigation mesh in the to-be-updated region and the virtual scene.

S303: Perform geometrization processing on the physical model to obtain to-be-processed mesh data. In an example, to-be-processed mesh data of the physical model is generated based on geometric data of the physical model in the to-be-updated region.

In the embodiments of this disclosure, because the data corresponding to the physical model is different in format from the data used for generating the navigation mesh, the update device performs geometrization processing on the physical model to implement conversion of the data corresponding to the physical model to the data used for generating the navigation mesh. The result obtained after the conversion is the to-be-processed mesh data, where a shape of each to-be-processed mesh in the to-be-processed mesh data is a specified geometric shape.

The geometrization processing is data conversion processing, which is used for converting geometric data corresponding to the physical model into geometric data used for generating the navigation mesh. The specified geometric shape is a geometric shape corresponding to the geometric data used for generating the navigation mesh, such as a triangle or a rectangle.

S304: Perform navigation processing on the to-be-processed mesh data to obtain a target navigation mesh. In an example, a target navigation mesh is generated based on the to-be-processed mesh data of the physical model in the to-be-updated region, the target navigation mesh indicating a passable route in the to-be-updated region.

In the embodiments of this disclosure, after obtaining the to-be-processed mesh data, the update device performs navigation processing based on the to-be-processed mesh data, to determine passable data based on the to-be-processed mesh data, and then generate a target navigation mesh based on the passable data.

The target navigation mesh is a navigation mesh regenerated by the update device for the to-be-updated region. It is easy to know that the target navigation mesh matches the to-be-updated region. The target navigation mesh is used for determining a passable route in the to-be-updated region.

S305: Update a to-be-updated navigation mesh corresponding to the to-be-updated region to the target navigation mesh. In an example, a to-be-updated navigation mesh corresponding to the to-be-updated region of the plurality of regions in the virtual scene is updated with the target navigation mesh.

In the embodiments of this disclosure, after obtaining the target navigation mesh, the update device updates a to-be-updated navigation mesh corresponding to the to-be-updated region based on the target navigation mesh, so that the navigation mesh in the to-be-updated region is the target navigation mesh.

The to-be-updated navigation mesh is an original navigation mesh corresponding to the to-be-updated region, and the original navigation mesh is the navigation mesh before the to-be-updated region has the scene change. In addition, when the virtual scene is a game scene, the to-be-updated navigation mesh may be pre-generated by the game engine.

It may be understood that, when the virtual scene has a scene change, by detecting a physical model in a to-be-updated region, a target navigation mesh corresponding to the to-be-updated region can be re-determined based on the physical model in the to-be-updated region, so that the navigation mesh can be updated in real time based on scene change in the rendering process of the virtual scene. Therefore, the update of the navigation mesh can be implemented based on the physical model in the to-be-updated region, so that the update complexity of the navigation mesh can be reduced, and the update efficiency of the navigation mesh can be improved. In addition, the degree of matching between the navigation mesh and the virtual scene can also be improved, so that when a passable route is determined based on the target navigation mesh, the accuracy of navigation can be improved.

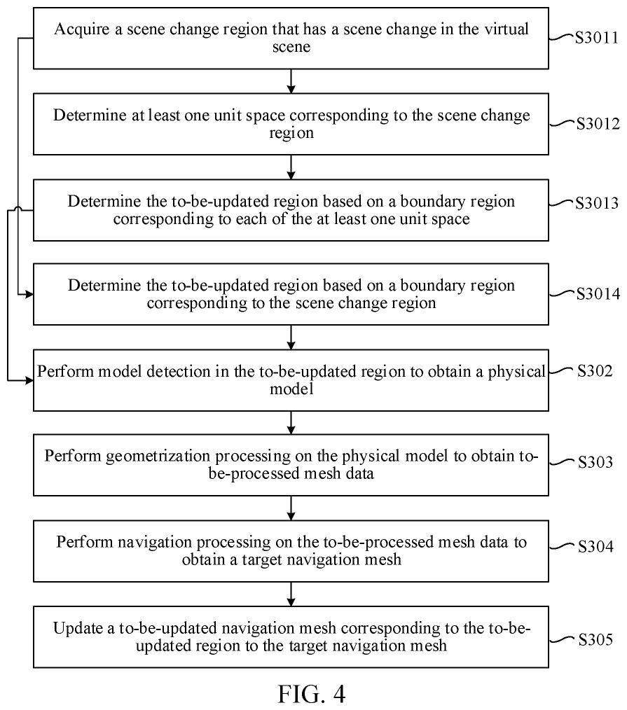

FIG. 4 is a schematic flowchart 2 of a navigation mesh update method according to an embodiment of this disclosure. As shown in FIG. 4, in this embodiment of this disclosure, S301 in FIG. 3 may be implemented through S3011 to S3013. That is, that the update device acquires a to-be-updated region that has a scene change in a virtual scene includes S3011 to S3013, and the steps are respectively described below.

S3011: Acquire a scene change region that has a scene change in the virtual scene.

In the embodiments of this disclosure, the update device acquires a region that has a scene change in the virtual scene, that is, obtains the scene change region. The scene change region refers to all regions that has a scene change in the virtual scene.

S3012: Determine at least one unit space corresponding to the scene change region.

The virtual scene includes unit spaces of various specified sizes, so that the scene change region includes at least one unit space. The at least one unit space herein refers to unit spaces included in the scene change region.

S3013: Determine the to-be-updated region based on a boundary region corresponding to each of the at least one unit space.

In the embodiments of this disclosure, the update device may determine a boundary region corresponding to each unit space in the scene change region as the to-be-updated region. That is, the update device may update the navigation mesh in units of unit spaces.

It may be understood that, the update device implements the processing of updating the navigation mesh in units of unit spaces by determining each unit space in the scene change region as the to-be-updated region. In this way, on the one hand, the concurrency of the navigation mesh update can be improved, to improve the update efficiency of the navigation mesh; on the other hand, the update accuracy of the navigation mesh can also be improved.

Referring to FIG. 4, in this embodiment of this disclosure, after S3011, the method further includes S3014. That is, after the update device acquires the scene change region that has the scene change in the virtual scene, the navigation mesh update method further includes S3014, which will be described below.

S3014: Determine the to-be-updated region based on a boundary region corresponding to the scene change region.

The update device may determine the boundary region of each unit space in the scene change region as the to-be-updated region, and may also determine the boundary region of the scene change region as the to-be-updated region. When the update device determines a boundary region of the scene change region as the to-be-updated region, the navigation mesh is updated with the scene change region as a whole. In this case, the scene change region is the to-be-updated region.

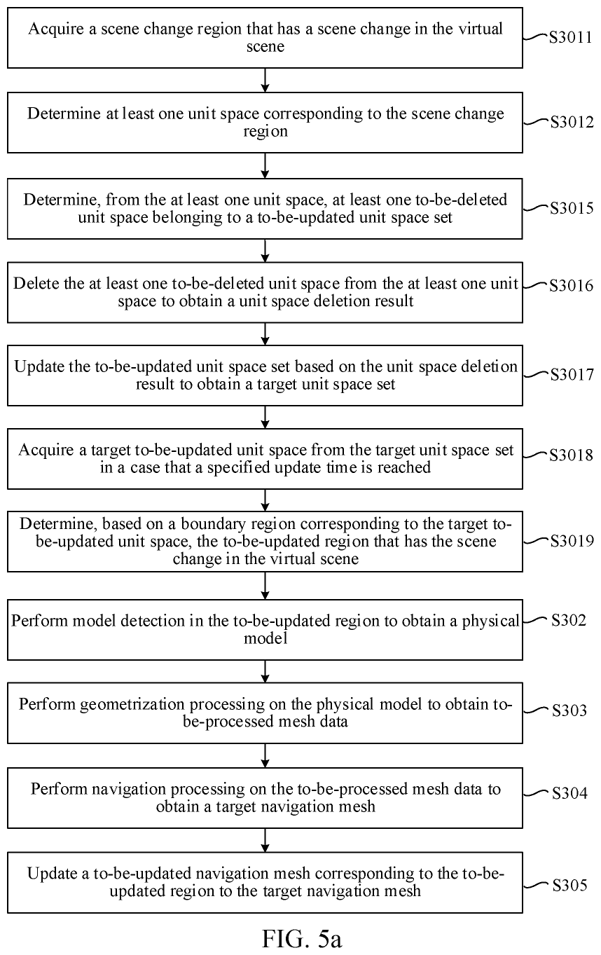

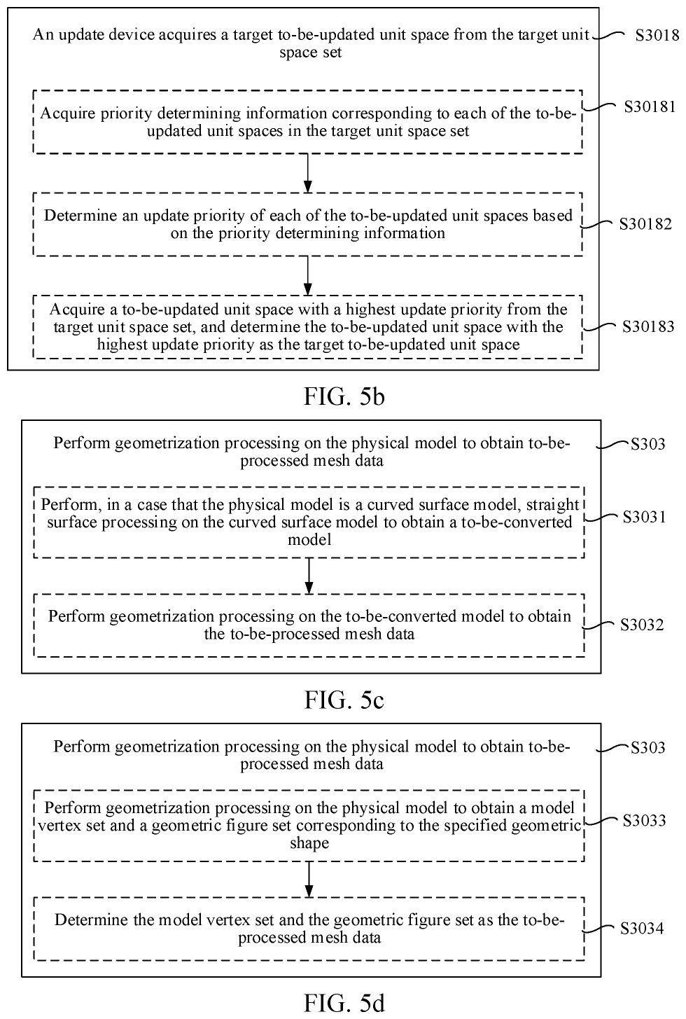

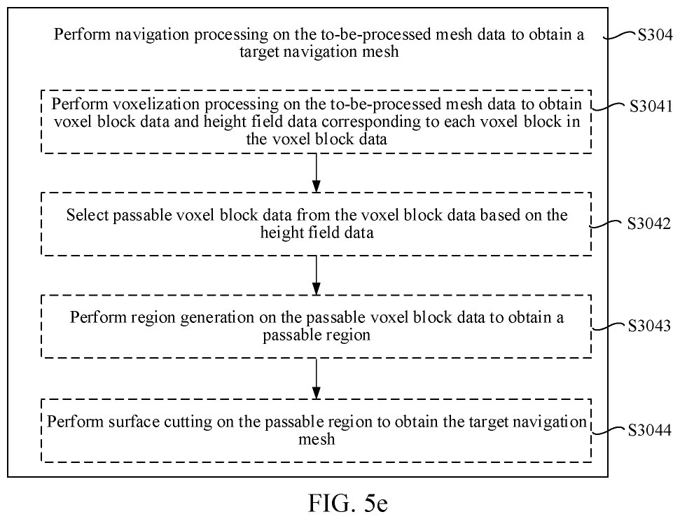

Based on FIG. 4, FIG. 5a is a schematic flowchart 3 of a navigation mesh update method according to an embodiment of this disclosure. As shown in FIG. 5a, in this embodiment of this disclosure, After S3012, the method further includes S3015 to S3017. That is, after the update device determines at least one unit space corresponding to the scene change region, the navigation mesh update method further includes S3015 to S3017, and the steps are respectively described below.

S3015: Determine, from the at least one unit space, at least one to-be-deleted unit space belonging to a to-be-updated unit space set.

In the embodiments of this disclosure, when updating the navigation mesh, the update device may acquire a unit space from the target unit space set to determine the to-be-updated region. Therefore, after obtaining at least one unit space in the scene change region, the update device updates the at least one unit space in the scene change region to a to-be-updated unit space set, to obtain the target unit space set, where the to-be-updated unit space set includes to-be-updated unit spaces that have a scene change. That is, the to-be-updated unit space set is used for caching unit spaces in which navigation meshes are to be updated.

When updating at least one unit space in the scene change region to the to-be-updated unit space set, the update device may directly update the at least one unit space to the to-be-updated unit space set, and may alternatively delete unit spaces belonging to the to-be-updated unit space set in the at least one unit space and then update the result to the to-be-updated unit space set. Each to-be-deleted unit space in the at least one to-be-deleted unit space is a unit space belonging to the to-be-updated unit space set in the at least one unit space.

The at least one unit space may not include unit spaces belonging to the to-be-updated unit space set. In this case, the update device updates all of the at least one unit space into the to-be-updated unit space set, thereby obtaining the target unit space set.

S3016: Delete the at least one to-be-deleted unit space from the at least one unit space to obtain a unit space deletion result.

In the embodiments of this disclosure, when the quantity of unit spaces in the at least one unit space is greater than the quantity of unit spaces in the at least one to-be-deleted unit space, the update device deletes the at least one to-be-deleted unit space from the at least one unit space, and obtains at least one to-be-updated unit space. That is, the at least one to-be-updated unit space is at least one unit space obtained after the at least one to-be-deleted unit space is deleted. When the quantity of unit spaces in the at least one unit space is equal to the quantity of unit spaces in the at least one to-be-deleted unit space, the update device deletes the at least one to-be-deleted unit space from the at least one unit space, and obtains a result representing no to-be-updated unit space. Therefore, the unit space deletion result may represent the remaining at least one to-be-updated unit space after the at least one to-be-deleted unit space is deleted from the at least one unit space, or may alternatively represent the result of no to-be-updated unit space, that is, the at least one unit space has been all deleted. This is not limited in the embodiments of this disclosure.

S3017: Update the to-be-updated unit space set based on the unit space deletion result to obtain a target unit space set.

In the embodiments of this disclosure, that the update device updates the to-be-updated unit space set based on the unit space deletion result to obtain a target unit space set includes that: when the unit space deletion result represents at least one to-be-updated unit space, because the at least one to-be-updated unit space is a unit space in which the navigation mesh is to be updated, the update device adds the at least one to-be-updated unit space to the to-be-updated unit space set, to obtain the target unit space set; and when the unit space deletion result indicates that the at least one unit space is all deleted, the update device determines the to-be-updated unit space set as the target unit space set.

It may be understood that, by deleting the at least one to-be-deleted unit space from the at least one unit space, a unit space in the at least one unit space that is already in the to-be-updated unit space set is deleted, so that repeated storage of a plurality of unit spaces in the to-be-updated unit space set is avoided, thereby reducing the repetition rate of update of the navigation mesh, and improving the update efficiency of the navigation mesh.

Still referring to FIG. 5a, in this embodiment of this disclosure, S301 in FIG. 3 may alternatively be implemented through S3018 and S3019. That is, that the update device acquires a to-be-updated region that has a scene change in a virtual scene includes S3018 and S3019, and the steps are respectively described below.

S3018: Acquire a target to-be-updated unit space from the target unit space set in a case that a specified update time is reached.

After the update device updates the at least one unit space in the to-be-updated region to the to-be-updated unit space set, and obtains the target unit space set, the update device may acquire the to-be-updated unit space from the target unit space set, so as to update the navigation mesh for the acquired to-be-updated unit space. The to-be-updated unit space acquired by the update device from the target unit space set herein is the target to-be-updated unit space.

S3019: Determine, based on a boundary region corresponding to the target to-be-updated unit space, the to-be-updated region that has the scene change in the virtual scene.

The update device may determine the boundary region corresponding to the target to-be-updated unit space as the to-be-updated region that has the scene change in the virtual scene.

It may be understood that, by determining the target to-be-updated unit space from the target unit space set, and determining the to-be-updated region that has the scene change in the virtual scene based on the target to-be-updated unit space, the repetition rate of update of the navigation mesh can be reduced, thereby improving the update accuracy and the update efficiency of the navigation mesh, and reducing the resource consumption.

FIG. 5b is a flowchart of acquiring a target to-be-updated unit space according to an embodiment of this disclosure. As shown in FIG. 5b, in this embodiment of this disclosure, S3018 in FIG. 5a may be implemented through S30181 to S30183. That is, that the update device acquires a target to-be-updated unit space from the target unit space set includes S30181 to S30183, and the steps are respectively described below.

S30181: Acquire priority determining information corresponding to each of the to-be-updated unit spaces in the target unit space set.

In the embodiments of this disclosure, during acquisition of the target to-be-updated unit space from the target unit space set, the update device may acquire any to-be-updated unit space from the target unit space set, or may acquire the target to-be-updated unit space from the target unit space set based on a priority, or the like, which is not limited in the embodiments of this disclosure.

During acquisition of the target to-be-updated unit space from the target unit space set based on the priority, the update device first acquires the priority determining information corresponding to each of the to-be-updated unit spaces in the target unit space set, the priority determining information being used for determining a priority of each to-be-updated unit space. The priority determining information includes at least one of a scene change duration, a virtual object distance, or scene data, where the scene change duration refers to a duration from the time at which the to-be-updated unit space has a scene change to the current time, the distance data refers to a distance between the to-be-updated unit space and the virtual object, and the scene data refers to feature data (for example, blasting region or terrain data) of the virtual scene.

S30182: Determine an update priority of each of the to-be-updated unit spaces based on the priority determining information.

In the embodiments of this disclosure, the update device refers to the priority corresponding to each to-be-updated unit space as an update priority. Herein, the update priority may be positively (or negatively) correlated with the scene change duration; and the update priority may be negatively correlated with the distance data, for example, the navigation mesh of the to-be-updated unit space with the shortest distance to the virtual object (which may be any object in the virtual scene, or may be a to-be-navigated virtual object) is first updated; and for example, relative to other regions, the update priority of the to-be-updated unit space in the blasting region is higher.

S30183: Acquire a to-be-updated unit space with a highest update priority from the target unit space set, and determine the to-be-updated unit space with the highest update priority as the target to-be-updated unit space.

The target to-be-updated unit space obtained by the update device herein is the to-be-updated unit space with the highest update priority in the target unit space set.

It may be understood that, the update device stores all the to-be-updated unit spaces in the target unit space set, and when the specified update time is reached, acquires the target to-be-updated unit space based on the update priority to update the navigation mesh, thereby improving the timeliness and accuracy of update of the navigation mesh. For example, when the update priority is positively correlated with the scene change duration, the update device updates the navigation mesh of the to-be-updated unit space with the highest update priority, which can ensure the orderly update of the to-be-updated unit spaces, thereby improving the update accuracy of the navigation mesh; when the update priority is negatively correlated with the distance data, because the interaction frequency at the region in which the virtual object is located is greater than those at other regions, the update device updates the navigation mesh of the to-be-updated unit space with the highest update priority, so that the timeliness of update of the navigation mesh of a to-be-updated unit space of the region at which the virtual object is located can be ensured, thereby improving the navigation effects based on the navigation mesh; and when the update priority is determined based on a region type of the virtual scene, the update device updates the navigation mesh of the to-be-updated unit space with the highest update priority, so that targeted update of the navigation mesh at the specified region can be implemented, thereby improving the navigation effects based on the navigation mesh.

In the embodiments of this disclosure, before S3015, the method further includes a process of determining validity of each unit space in the scene change region. That is, before that the update device determines, from the at least one unit space, at least one to-be-deleted unit space belonging to a to-be-updated unit space set, the navigation mesh update method further includes: acquiring, by the update device for the at least one unit space, a space size of each unit space in the scene change region; and determining a unit space of which the space size is greater than a first specified space size as a valid unit space.

The update device first determines the space size of each unit space in the at least one unit space in the scene change region, and then determines the validity of the corresponding unit space based on a comparison result between the space size and the first specified space size. The valid unit space is referred to as a valid unit space, a unit space of which the space size is larger than the first specified space size is a valid unit space, and a unit space of which the space size is smaller than or equal to the first specified space size is an invalid unit space. The first specified space size herein is a threshold determined based on the size of the unit space. It is easy to know that the first specified space size is smaller than the size of the unit space. For example, the first specified space is half the size of the unit space.

Correspondingly, in this embodiment of this disclosure, that the update device determines, from the at least one unit space, at least one to-be-deleted unit space belonging to a to-be-updated unit space set in S3015 includes: determining, by the update device from at least one valid unit space corresponding to the at least one unit space, the at least one to-be-deleted unit space belonging to the to-be-updated unit space set.

The update device determines the validity of each unit space in the at least one unit space and ensures that the determining of repeated storage (that is, the process of determining whether the unit space belongs to the to-be-updated unit space set) is only performed when the unit space is a valid unit space. In this way, for a unit space at the edge of the scene change region, if the size of the unit space falling within the scene change region is relatively large (that is, the space size is larger than the first specified space size), it indicates that the scene change has a relatively great impact on the unit space, and only in this case, the navigation mesh of the unit space is updated. If the size of the unit space falling within the scene change region is relatively small (that is, the space size is less than or equal to the first specified space size), it indicates that the scene change has little impact on the unit space. In this case, update of the navigation mesh of the unit space is canceled. Therefore, the accuracy of the determined region of which the navigation mesh is to be updated can be improved, thereby improving the update accuracy of the navigation mesh.

In the embodiments of this disclosure, before S3011, the method further includes the process of dividing the virtual scene. That is, before that the update device acquires a scene change region that has a scene change in the virtual scene, the navigation mesh update method further includes: dividing, by the update device, the virtual scene based on a second specified space size to obtain a unit space set.

The update device divides the virtual scene in advance to update the navigation mesh based on the unit space. Herein, the basis for the update device to divide the virtual scene may be the second specified space size. After the division is completed, the virtual scene will be divided into unit spaces, where the unit space set includes the unit spaces corresponding to the virtual scene. It is easy to know that the second specified space size is the size of the unit space, and the second specified space size is the basic unit threshold for dividing the virtual scene, for example, a length, a width, and a height of specified sizes.

It may be understood that, the virtual scene is divided, so that the virtual scene is formed by unit spaces. In this way, when the scene changes, update of the navigation mesh can be performed separately for the at least one unit space that has a scene change in the virtual scene. For example, the update of the navigation mesh of the at least one unit space may be processed in parallel, so that the update efficiency of the navigation mesh can be improved. In addition, by dividing the virtual scene, navigation meshes correspond to unit spaces. That is, the navigation mesh of the virtual scene is formed by the navigation meshes respectively corresponding to the unit spaces. Therefore, when the scene changes, the navigation mesh is updated in units of unit spaces, rather than being updated by using the virtual scene as a whole, so that the resource consumption of the update of the navigation mesh can be reduced.

FIG. 5c is a flowchart 1 of acquiring to-be-processed mesh data according to an embodiment of this disclosure. As shown in FIG. 5c, in this embodiment of this disclosure, S303 in FIG. 3 may be implemented through S3031 and S3032. That is, that the update device performs geometrization processing on the physical model to obtain to-be-processed mesh data includes S3031 and S3032. The steps are respectively described below.

S3031: Perform, in a case that the physical model is a curved surface model, straight surface processing on the curved surface model to obtain a to-be-converted model.

S3032: Perform geometrization processing on the to-be-converted model to obtain the to-be-processed mesh data.

When the update device performs geometrization processing on the physical model, the manner of the geometrization processing may be determined based on the shape of the graphics included in the physical model. Herein, because the to-be-processed mesh data used for determining the navigation mesh is linear graphic data, in the process of acquiring the to-be-processed mesh data based on the physical model, when the physical model is a straight surface model (such as a height map, a triangular mesh, or a cube), the update device directly performs geometrization processing on the straight surface model to obtain the to-be-processed mesh data. When the physical model is a curved surface model (such as a capsule body or a sphere), the update device performs straight surface processing on the curved surface model to convert the curved surface model into a straight surface model and then performs geometrization processing to obtain to-be-processed mesh data, where the to-be-converted model is the straight surface model. In addition, the straight surface processing refers to the process of converting the curved-surface graphics in the curved surface model into straight line graphics, for example, the processing of acquiring a circumscribed rectangular bounding box of the curved surface model.

In the embodiments of this disclosure, the update device may obtain the to-be-processed mesh data by performing straight surface processing on the curved surface model through S3031 and S3032, may alternatively obtain the to-be-processed mesh data by performing rasterization with a specified geometric shape on the curved surface of the curved surface model, or the like, which is not limited in the embodiments of this disclosure. Rasterization refers to a process of mapping the curved surface model into two-dimensional coordinate points and constructing a triangle based on the two-dimensional coordinate points.

It may be understood that, in the process of performing straight surface processing on the curved surface model by the update device, a straight surface model approximate to the curved surface model is first acquired, and then the geometrization processing on the straight surface model is used as geometrization processing on the curved surface model. Because the geometrization processing on the straight surface model can be implemented through line division, by acquiring the approximate straight surface model and through line division, the geometrization processing on the curved surface model can be implemented, so that the efficiency of geometrization processing can be improved, thereby improving the update efficiency of the navigation mesh.

FIG. 5d is a flowchart 2 of acquiring to-be-processed mesh data according to an embodiment of this disclosure. As shown in FIG. 5d, in this embodiment of this disclosure, S303 in FIG. 3 may alternatively implemented through S3033 and S3034. That is, that the update device performs geometrization processing on the physical model to obtain to-be-processed mesh data includes S3033 and S3034. The steps are respectively described below.

S3033: Perform geometrization processing on the physical model to obtain a model vertex set and a geometric figure set corresponding to the specified geometric shape.

S3034. Determine the model vertex set and the geometric figure set as the to-be-processed mesh data.

In the embodiments of this disclosure, when the update device performs geometrization processing on the physical model, the obtained to-be-processed mesh data of the specified geometric shape includes the model vertex set and the geometric figure array corresponding to the specified geometric shape. Each geometric figure in the geometric figure set includes a vertex index, the geometric shape of the geometric figure is the specified geometric shape, and the vertex index is used for determining a model vertex in the model vertex data.

It may be understood that, the model vertex set and the geometric figure set are used to describe the to-be-processed mesh data based on the result of geometrization processing. Because the geometric figure set includes vertex indexes of the vertices of each geometric figure, reuse of model vertices can be implemented, thereby reducing the storage resources of the to-be-processed mesh data, and then reducing the resource consumption of updating the navigation mesh.

FIG. 5e is a flowchart of acquiring a target navigation mesh according to an embodiment of this disclosure. As shown in FIG. 5e, in this embodiment of this disclosure, S304 in FIG. 3 may be implemented through S3041 to S3044. That is, that the update device performs navigation processing on the to-be-processed mesh data to obtain a target navigation mesh includes S3041 to S3044, and the steps are respectively described below.

S3041: Perform voxelization processing on the to-be-processed mesh data to obtain voxel block data and height field data corresponding to each voxel block in the voxel block data.

S3042: Select passable voxel block data from the voxel block data based on the height field data.

The update device performs voxelization processing on the to-be-processed mesh data to select passable voxel blocks. All the selected passable voxel blocks herein are referred to as passable voxel block data. That is, the passable voxel block data includes the passable voxel blocks.

The to-be-processed mesh data refers to data that describes a region through a mesh of the specified geometric figure. The voxelization processing refers to the process of uniformly dividing the region corresponding to the to-be-processed mesh data according to a third specified space size. Each unit obtained through the division is a voxel block, and the result obtained through the division is voxel block data. The voxel block data includes the voxel blocks. The height field data includes the height corresponding to the voxel block, and a height difference between the voxel block data and adjacent voxel block data. Herein, the update device may select the passable voxel blocks based on a height threshold and a height difference threshold. During the selection, the update device determines voxel blocks of which the heights are less than the height threshold and the height differences are less than the height difference threshold as passable voxel blocks based on the height field data.

S3043: Perform region generation on the passable voxel block data to obtain a passable region.

The region generation refers to the process of acquiring the region of the passable voxel block data by the update device. Herein, the update device acquires a region corresponding to each passable voxel block in the passable voxel block data, and combines the obtained region corresponding to each passable voxel block, thereby obtaining the passable region corresponding to the passable voxel blocks.

S3044: Perform surface cutting on the passable region to obtain the target navigation mesh.

The update device performs surface cutting on the passable region to convert the passable region into a data format corresponding to the navigation mesh, thereby obtaining the target navigation mesh. The surface cutting may include the process of integrating subregions in the passable region into mesh data of specified geometric shapes (for example, a triangle).

It may be understood that, because the to-be-processed mesh data is mesh data of the specified geometric shape corresponding to the physical model, the update device obtains target navigation mesh data by sequentially performing voxelization processing, selection, region generation, and surface cutting on the to-be-processed mesh data, which implements the process of updating the navigation mesh based on the physical model, so as to implement update of the navigation mesh independent of a virtual engine (for example, a game engine), thereby increasing update efficiency of the navigation mesh and reducing resource consumption of the navigation mesh.

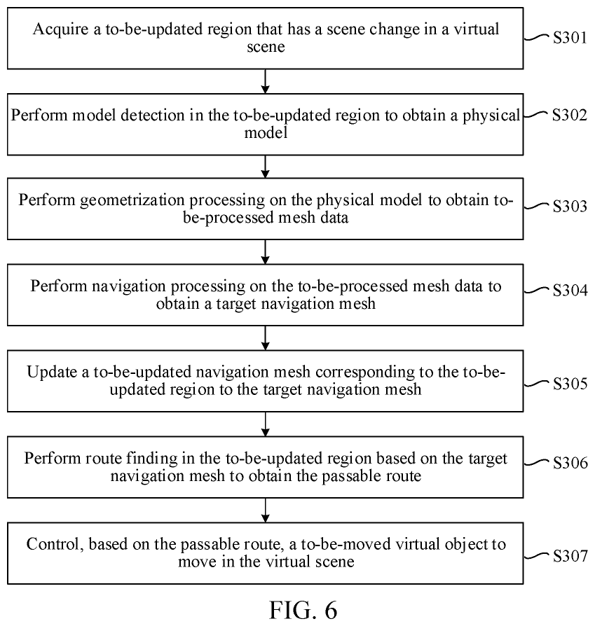

FIG. 6 is a schematic flowchart 4 of a navigation mesh update method according to an embodiment of this disclosure. As shown in FIG. 6, in this embodiment of this disclosure, After S305, the method further includes S306 and S307. That is, after that the update device updates a to-be-updated navigation mesh corresponding to the to-be-updated region to the target navigation mesh, the navigation mesh update method further includes S306 and S307, and the steps are respectively described below.

S306: Perform route finding in the to-be-updated region based on the target navigation mesh to obtain the passable route.

The update device performs route finding in the to-be-updated region based on the target navigation mesh to obtain a route that is passable in the to-be-updated region. Herein, the update device refers to the route that is passable in the to-be-updated region as a passable route.

S307: Control, based on the passable route, a to-be-moved virtual object to move in the virtual scene.

The update device may control the to-be-moved virtual object to move in the virtual scene based on the passable route in the update device, and may alternatively send the passable route to a rendering device, so that the rendering device may control the to-be-moved virtual object to move in the virtual scene based on the passable route. The rendering device is, for example, a terminal running a game client.

The following describes an exemplary application of this embodiment of this disclosure in an actual application scenario. This exemplary application describes the process of automatically updating the navigation mesh in real time to accurately perform route finding for an intelligent agent based on scene change detection in a process in which the game scene (referred to as a virtual scene) is that an intelligent agent (referred to as a to-be-moved virtual object) performs route finding.

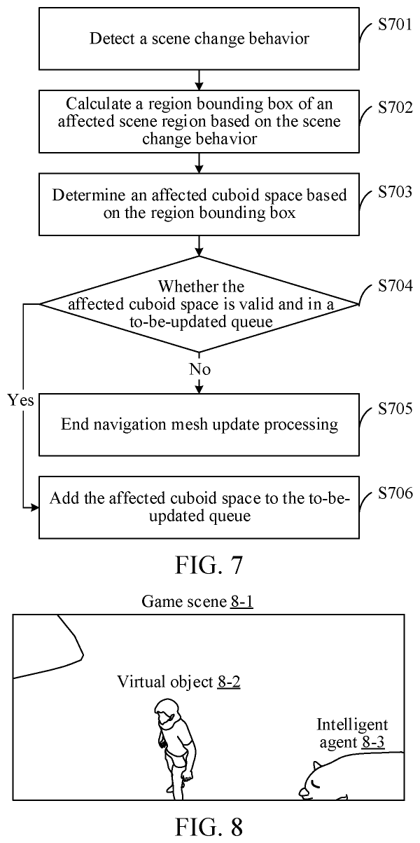

FIG. 7 is a schematic flowchart of an exemplary navigation mesh update method according to an embodiment of this disclosure. As shown in FIG. 7, the exemplary navigation mesh update method includes S701 to S706, and the steps are respectively described below.

S701: Detect a scene change behavior.

A server detects a player's behavior by detecting behavior data. When a construction behavior, a terrain destruction behavior, and behaviors such as blocking and departure of the rigid body model that affect the game scene of the player are detected in the game scene, a scene change behavior is detected, which indicates that the game scene has a change.

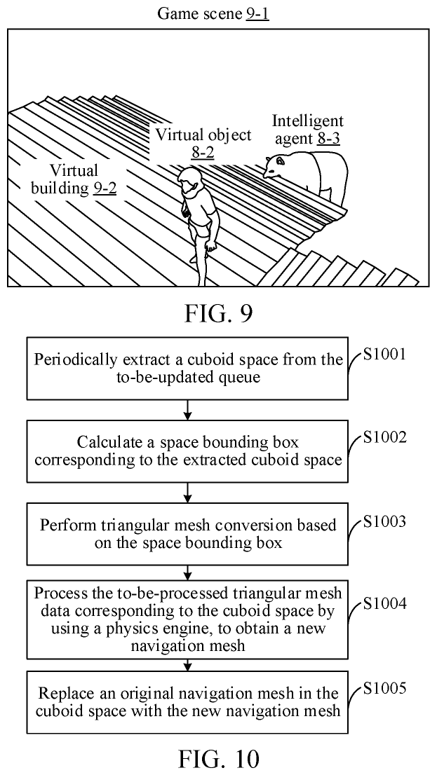

For example, FIG. 8 is a schematic diagram of an exemplary game scene according to an embodiment of this disclosure. As shown in FIG. 8, an initial game scene 8-1 includes a virtual object 8-2 and an intelligent agent 8-3. When the virtual object 8-2 performs construction in the game scene 8-1, the server detects the scene change behavior. FIG. 9 is a schematic diagram of another exemplary game scene according to an embodiment of this disclosure. As shown in FIG. 9, in response to a construction operation, the server interacts with a game client with the game scene 9-1 having a rendering change. In this case, the virtual object 8-2 is on a virtual building 9-2 constructed in the game scene 9-1. Herein, because the initial game scene 8-1 has a change, and is changed to the game scene 9-1, the server updates a navigation mesh (referred to as a to-be-updated navigation mesh) of the game scene 8-1 based on the game scene 9-1, so that the intelligent agent 8-3 may move on the virtual building 9-2 based on the updated navigation mesh (referred to as a target navigation mesh).

S702: Calculate a region bounding box of an affected scene region (referred to as a scene change region) based on the scene change behavior.

The affected scene region herein is, for example, a region in which construction occurs in FIG. 9.

S703: Determine an affected cuboid space (Tile, referred to as a unit space) based on the region bounding box.

The game scene is formed by cuboid spaces with fixed lengths and widths (referred to as the second specified space size), each cuboid space corresponds to its navigation mesh, and the navigation meshes of all the cuboid spaces form the navigation mesh of the game scene. Herein, the server combines the navigation meshes of all the cuboid spaces into the navigation mesh of the game scene by processing the connection relationship between adjacent cuboid spaces. In addition, the connection relationship of the navigation meshes between the cuboid spaces may be described by common edges.

For example, when the game scene changes, it is determined that the region bounding box corresponding to the affected scene region is bₘᵢₙ, bₘₐₓ. In this case, the cuboid space in the affected scene region (that is, the affected cuboid space, referred to as at least one unit space) may be determined by Formula (1) and Formula (2), and Formula (1) and Formula (2) are shown as follows respectively.

Tileₘᵢₙ=GetTileIndex(bₘᵢₙX,bₘᵢₙY) (1)

Tileₘₐₓ=GetTileIndex(bₘₐₓX,bₘₐₓY) (2)
where {Tileₘᵢₙ, . . . , Tileₘₐₓ} represents an index set of affected cuboid spaces; bₘᵢₙX and bₘᵢₙY are obtained through bₘᵢₙ, bₘₐₓX and bₘₐₓY are obtained through bₘₐₓ; and GetTileIndex( ) may be implemented by Formula (3), where Formula (3) is shown as follows.

GetTileIndex(inputX,inputY)=GetTileIndexSingle(inputX,kTileWidth)*kOffset+GetTileIndexSingle(inputY,kTileHeight) (3)
where (inputX, inputY) is two-dimensional coordinates, corresponding to the two-dimensional coordinate bₘᵢₙX, bₘᵢₙY or bₘₐₓX, bₘₐₓY of the region bounding box; kOffset, kTileWidth, and kTileHeight are constant parameters, which are all positively related to the size of the game scene; GetTileIndexSingle( ) means acquiring the index of the cuboid space in one dimension, including a parameter 1 and a parameter 2, which can be obtained by parameter 1 modulo parameter 2.

S704: Determine whether the affected cuboid space is valid and in a to-be-updated queue (referred to as a to-be-updated unit space set). If it is, perform S706; otherwise, perform S705.

The to-be-updated queue is used for storing all affected cuboid spaces, and the storage of all affected cuboid spaces can be implemented by storing the indexes of the affected cuboid spaces, so that the server determines whether the affected cuboid spaces are in the to-be-updated queue based on the indexes of the cuboid spaces. Herein, the server may determine, based on a space size of each cuboid space falling in the affected scene region, whether the cuboid space is valid. For example, when the space size falling in the affected scene region is greater than half of the size of the cuboid space, it can be determined that the corresponding cuboid space is valid; otherwise, it is invalid.

S705: End navigation mesh update processing.

S706: Add the affected cuboid space to the to-be-updated queue.

Herein, the server implements addition of the affected cuboid spaces to the to-be-updated queue by adding the indexes of the affected cuboid spaces to the to-be-updated queue.

The following describes the process of updating the navigation mesh based on the to-be-updated queue.

FIG. 10 is a schematic flowchart of an exemplary navigation mesh update method according to an embodiment of this disclosure. As shown in FIG. 10, the exemplary navigation mesh update method includes S1001 to S1005, and the steps are respectively described below.

S1001: Periodically extract a cuboid space (referred to as a target to-be-updated unit space) from the to-be-updated queue.

S1002: Calculate a space bounding box corresponding to the extracted cuboid space.

S1003: Perform triangular mesh conversion (referred to as geometrization processing) based on the space bounding box.

The server uses a physics engine (for example, “PhysX” physics engine) to update the navigation mesh, because the data format corresponding to the physics engine is triangular mesh data, the server first performs triangular mesh conversion based on the space bounding box. The process of triangular mesh conversion is described below.

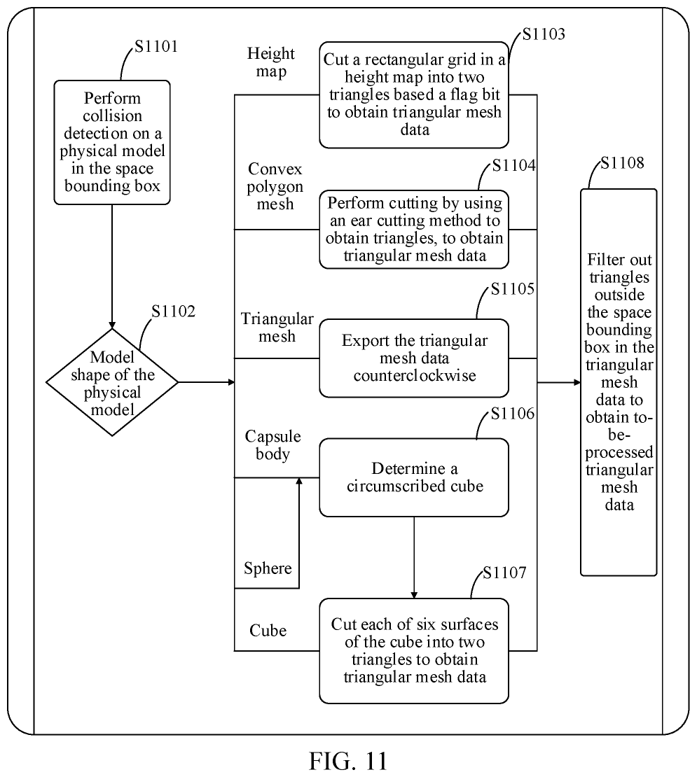

FIG. 11 is a schematic diagram of exemplary geometrization processing according to an embodiment of this disclosure. As shown in FIG. 11, the exemplary geometrization processing process includes S1101 to S1108, and the steps are respectively described below.

S1101: Perform collision detection on a physical model in the space bounding box.

The server uses the collision query function of the physics engine to input the minimum coordinates and maximum coordinates of the space bounding box as parameters for collision detection, to obtain all the physical models in the space bounding box.

S1102: Determine a model shape of the physical model.

When the model shape is a height map, S1103 is performed; when the model shape includes a convex polygon, that is, being a convex polygon mesh, S1104 is performed; when the model shape includes a triangle, that is, being a triangular mesh, S1105 is performed; when the model shape is a capsule body or a sphere, S1106 is performed; and when the model shape is a cube, S1107 is performed.

S1103: Cut a rectangular grid in a height map into two triangles based a flag bit to obtain triangular mesh data.

The height map includes rectangles arranged one by one. Herein, the server divides each rectangle into two triangles based on the flag bit to obtain the triangle mesh data corresponding to the height map. The flag bit is the triangle division manner corresponding to each rectangle in the height map. For example, for the four vertices of the rectangle: vertex 1, vertex 2, vertex 3 and vertex 4, the rectangle may be cut into two triangles through a connection line between the vertex 1 and the vertex 3 in a diagonal relationship, and the rectangle may alternatively be cut into two triangles through a connection line between the vertex 2 and the vertex 4 in a diagonal relationship. Herein, the flag bit is used for determining whether to perform triangular cutting based on the vertex 1 and the vertex 3, or perform triangular cutting based on the based on the vertex 2 and the vertex 4.

S1104: Perform cutting by using an ear cutting method to obtain triangles, to obtain triangular mesh data.

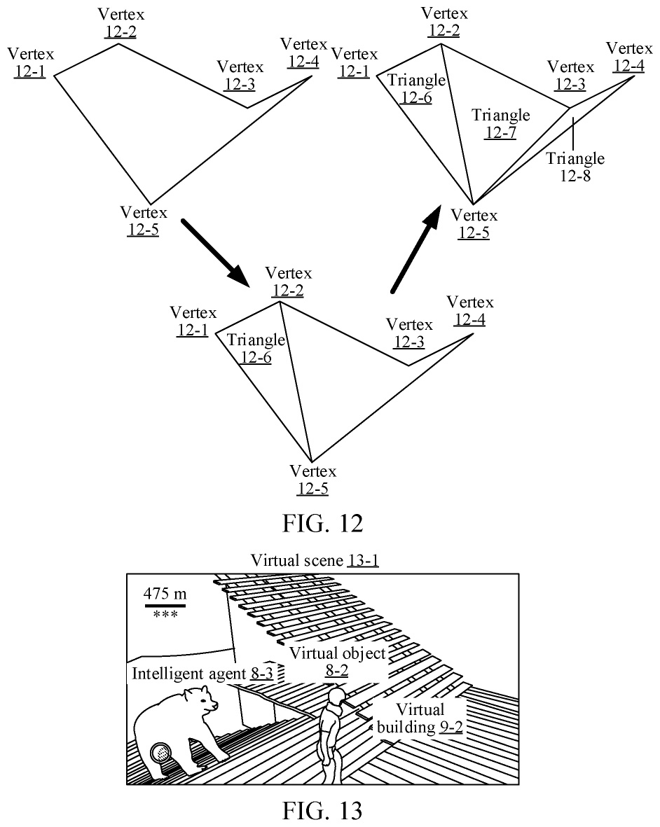

For the physical model including the convex polygon, the server obtains the triangles corresponding to the convex polygon by using the ear cutting method, so as to obtain triangle mesh data corresponding to the physical model of the convex polygon. The ear cutting method may include the process of converting a convex polygon into a set of triangles including the same vertices. In the process of triangulating a convex polygon through the ear cutting method, triangle cutting is performed by continuously determining the ears of the convex polygon. Herein, the ears of the convex polygon refer to a triangle formed by consecutive vertices V0, V1, and V2 and containing no other convex polygon vertices inside. FIG. 12 is an exemplary process of performing triangle cutting on a convex polygon according to an embodiment of this disclosure. As shown in FIG. 12, for a convex polygon including a vertex 12-1, a vertex 12-2, a vertex 12-3, a vertex 12-4, and a vertex 12-5, the determined first ear is a triangle 12-6 formed by the vertex 12-1, the vertex 12-2, and the vertex 12-5, the determined second ear is a triangle 12-7 formed by the vertex 12-2, the vertex 12-3, and the vertex 12-5, and the determined last ear is a triangle 12-8 formed by the vertex 12-3, the vertex 12-4, and the vertex 12-5. Therefore, the convex polygon is cut into three triangles: the triangle 12-6, the triangle 12-7, and the triangle 12-8.

S1105: Export the triangular mesh data counterclockwise.

When the physical model includes triangles, the physical model is already a set of triangles. However, because the triangles in the set of triangles corresponding to the physical model are arranged clockwise, and the triangles processed by the physics engine are arranged counterclockwise, in order to perform standardization processing, the server rearranges all triangles included in the physical model in a counterclockwise order, that is, obtains triangle mesh data.

S1106: Determine a circumscribed cube. S1107 is performed.

For capsule body physical models and sphere physical models, the server may obtain triangular mesh data by performing triangular rasterization on the curved surfaces, and may alternatively obtain triangular mesh data by using a circumscribed cube (referred to as straight surface processing).

S1107: Cut each of six surfaces of the cube into two triangles to obtain triangular mesh data.

Herein, for the cube, the server performs triangular division by connecting vertices of the rectangles with six surfaces.

S1108. Filter out triangles outside the space bounding box in the triangular mesh data to obtain to-be-processed triangular mesh data (referred to as to-be-processed mesh data).

In order to save storage space, the server uses a vertex array (referred to as a model vertex set) and a triangle array (referred to as a geometric figure set) to represent the to-be-processed triangular mesh data. The triangle array includes an index of the vertex array, so that the reuse of vertex coordinates can be implemented, thereby saving the storage space.

S1004: Process the to-be-processed triangular mesh data corresponding to the cuboid space by using a physics engine, to obtain a new navigation mesh (referred to as a target navigation mesh).

The physics engine sequentially performs processing such as voxelization for height field generation, region generation, merging, surface cutting (for example, triangle cutting) and convex polygon generation on the to-be-processed triangular mesh data, to obtain a new navigation mesh.

S1005: Replace an original navigation mesh (referred to as a to-be-updated navigation mesh) in the cuboid space with the new navigation mesh.

For example, FIG. 13 is a schematic diagram of exemplary route finding according to an embodiment of this disclosure. As shown in FIG. 13, after replacement with a new navigation mesh for each cuboid space in the affected scene region in the game scene 9-1 in FIG. 9 is completed, the server completes update processing of the navigation mesh of the game scene 8-1 based on the game scene 9-1. In this case, the server determines a passable route of the intelligent agent 8-3 based on the updated navigation mesh, so that in the virtual scene 13-1, the intelligent agent 8-3 can move on the virtual building 9-2.

It may be understood that, during the running of the game client, a navigation mesh is dynamically generated based on the physics engine and is updated, which implements the decoupling of the navigation mesh update from the game engine, improves the update efficiency of the navigation mesh, and reduces the resource consumption of update of the navigation mesh. In addition, through the division of cuboid space Tile and the to-be-updated queue, the update efficiency of the navigation mesh is improved in terms of time and space, and the repetition rate of the update of the navigation mesh is reduced.

The following continues to describe an exemplary structure in which the navigation mesh update apparatus 455 provided in the embodiments of this disclosure is implemented as software modules. In some embodiments, as shown in FIG. 2, the software modules in the navigation mesh update apparatus 455 stored in the memory 450 may include a region determining module 4551, a model detection module 4552, a data conversion module 4553, a mesh generation module 4554, and a mesh update module 4555. One or more modules, submodules, and/or units of the apparatus can be implemented by processing circuitry, software, or a combination thereof, for example.

The region determining module 4551 is configured to acquire a to-be-updated region that has a scene change in a virtual scene.

The model detection module 4552 is configured to detect a physical model in the to-be-updated region; =.

The data conversion module 4553 is configured to perform geometrization processing on the physical model to obtain to-be-processed mesh data, a shape of each to-be-processed mesh in the to-be-processed mesh data being a specified geometric shape.

The mesh generation module 4554 is configured to perform navigation processing on the to-be-processed mesh data to obtain a target navigation mesh, the target navigation mesh being used for determining a passable route in the to-be-updated region, and the specified geometric shape being a geometric shape corresponding to the navigation processing.

The mesh update module 4555 is configured to update a to-be-updated navigation mesh corresponding to the to-be-updated region to the target navigation mesh, the to-be-updated navigation mesh being an original navigation mesh corresponding to the to-be-updated region.

In the embodiments of this disclosure, the region determining module 4551 is further configured to: acquire a scene change region that has a scene change in the virtual scene; determine at least one unit space corresponding to the scene change region; and determine the to-be-updated region based on a boundary region corresponding to each of the at least one unit space.

In the embodiments of this disclosure, the region determining module 4551 is further configured to: determine, from the at least one unit space, at least one to-be-deleted unit space belonging to a to-be-updated unit space set, the to-be-updated unit space set including to-be-updated unit spaces that have scene changes; delete the at least one to-be-deleted unit space from the at least one unit space to obtain a unit space deletion result; and update the to-be-updated unit space set based on the unit space deletion result to obtain a target unit space set; and

In the embodiments of this disclosure, the region determining module 4551 is further configured to: acquire a target to-be-updated unit space from the target unit space set in a case that a specified update time is reached; and determine, based on a boundary region corresponding to the target to-be-updated unit space, the to-be-updated region that has the scene change in the virtual scene.

In the embodiments of this disclosure, the region determining module 4551 is further configured to: update, in a case that the unit space deletion result represents at least one to-be-updated unit space, the at least one to-be-updated unit space into the to-be-updated unit space set, to obtain the target unit space set; and determine the to-be-updated unit space set as the target unit space set in a case that the unit space deletion result indicates that the at least one unit space is all deleted.

In the embodiments of this disclosure, the region determining module 4551 is further configured to: acquire priority determining information corresponding to each of the to-be-updated unit spaces in the target unit space set, the priority determining information including at least one of a scene change duration, a virtual object distance, or scene data, the virtual object distance referring to a distance between the to-be-updated unit space and a virtual object, and the scene data referring to feature data of the virtual scene; determine an update priority of each of the to-be-updated unit spaces based on the priority determining information; and acquire a to-be-updated unit space with a highest update priority from the target unit space set, and determine the to-be-updated unit space with the highest update priority as the target to-be-updated unit space.

In the embodiments of this disclosure, the region determining module 4551 is further configured to: acquire, for the at least one unit space, a space size of each unit space in the scene change region; and determine a unit space of which the space size is greater than a first specified space size as a valid unit space; and

In the embodiments of this disclosure, the region determining module 4551 is further configured to: determine, from at least one valid unit space corresponding to the at least one unit space, the at least one to-be-deleted unit space belonging to the to-be-updated unit space set.

In the embodiments of this disclosure, the navigation mesh update apparatus 455 further includes a space division module 4556, configured to: divide the virtual scene based on a second specified space size to obtain a unit space set, the unit space set including unit spaces corresponding to the virtual scene.

In the embodiments of this disclosure, the region determining module 4551 is further configured to: determine the to-be-updated region based on a boundary region corresponding to the scene change region.

In the embodiments of this disclosure, The data conversion module 4553 is further configured to: perform, in a case that the physical model is a curved surface model, straight surface processing on the curved surface model to obtain a to-be-converted model; and perform geometrization processing on the to-be-converted model to obtain the to-be-processed mesh data of the specified geometric shape.

In the embodiments of this disclosure, The data conversion module 4553 is further configured to: perform geometrization processing on the physical model to obtain a model vertex set and a geometric figure set corresponding to the specified geometric shape, each geometric figure in the geometric figure set including a vertex index, the vertex index being used for determining a model vertex in the model vertex set; and determine the model vertex set and the geometric figure set as the to-be-processed mesh data.

In the embodiments of this disclosure, the mesh generation module 4554 is further configured to: perform voxelization processing on the to-be-processed mesh data to obtain voxel block data and height field data corresponding to each voxel block in the voxel block data; select passable voxel block data from the voxel block data based on the height field data; perform region generation on the passable voxel block data to obtain a passable region; and perform surface cutting on the passable region to obtain the target navigation mesh.

In the embodiments of this disclosure, the navigation mesh update apparatus 455 further includes a mesh route finding module 4557, configured to: perform route finding in the to-be-updated region based on the target navigation mesh to obtain the passable route; and control, based on the passable route, a to-be-moved virtual object to move in the virtual scene.

An embodiment of this disclosure provides a computer program product or a computer program. The computer program product or the computer program includes computer executable instructions, the computer executable instructions being stored in a computer-readable storage medium. A processor of an electronic device reads the computer executable instructions from the computer-readable storage medium and executes the computer executable instructions to cause the electronic device to perform the foregoing navigation mesh update method in the embodiments of this disclosure.

An embodiment of this disclosure provides a computer-readable storage medium, such as a non-transitory computer-readable storage medium, storing computer executable instructions. When the computer executable instructions are executed by a processor, the processor is caused to perform the navigation mesh update method provided in the embodiments of this disclosure, for example, the navigation mesh update method shown in FIG. 3.

In some embodiments, the computer-readable storage medium may be a memory such as an FRAM, a ROM, a PROM, an EPROM, an EEPROM, a flash memory, a magnetic memory, a compact disc, or a CD-ROM; or may be various devices including one of or any combination of the foregoing memories.

In some embodiments, the computer executable instructions can be written in the form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts).

For example, the computer executable instructions may be deployed for execution on one electronic device (in this case, the one electronic device is an update device), execution on a plurality of electronic devices located at one location (in this case, the plurality of electronic devices located at one location are update devices), or execution on a plurality of electronic devices that are distributed at a plurality of locations and that are interconnected through a communication network (in this case, the plurality of electronic devices that are distributed at a plurality of locations and that are interconnected through a communication network are update devices).

The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

It may be understood that, in the embodiments of this disclosure, relevant data such as scene data are involved. When the embodiments of this disclosure are applied to a specific product or technology, user permission or consent needs to be obtained, and the collection, use, and processing of relevant data need to comply with relevant laws, regulations, and standards of relevant countries and regions.

Based on the above, in the embodiments of this disclosure, when a virtual scene has a scene change, by performing physical model detection in a to-be-updated region, a target navigation mesh corresponding to the to-be-updated region can be re-determined based on the physical model in the to-be-updated region, and then the navigation mesh can be updated in real time based on the scene change in a rendering process of the virtual scene, and the degree of matching between the navigation mesh and the virtual scene is relatively high, so that when a passable route is determined based on the target navigation mesh, the accuracy of navigation can be improved. In addition, the update of the navigation mesh can be implemented based on the physical model in the to-be-updated region, so that the update complexity of the navigation mesh can be reduced, and the update efficiency of the navigation mesh can be improved.

The foregoing descriptions are merely exemplary embodiments of this disclosure and are not intended to limit the protection scope of this disclosure. Any modification, equivalent replacement, or improvement made without departing from the spirit and scope of this disclosure shall fall within the protection scope of this disclosure.

What is claimed is:

1. A navigation mesh update method, the method comprising:
determining a to-be-updated region that includes a scene change in a virtual scene, the to-be-updated region being one of a plurality of regions in the virtual scene;
obtaining a physical model of a virtual object in the to-be-updated region;
generating to-be-processed mesh data of the physical model based on geometric data of the physical model in the to-be-updated region;
generating, by processing circuitry, a target navigation mesh based on the to-be-processed mesh data of the physical model in the to-be-updated region, the target navigation mesh indicating a passable route in the to-be-updated region; and
updating a to-be-updated navigation mesh corresponding to the to-be-updated region of the plurality of regions in the virtual scene with the target navigation mesh.

2. The method according to claim 1, wherein the scene change corresponds to one of movement, construction, and removal of the virtual object.

3. The method according to claim 1, wherein the determining the to-be-updated region comprises:
determining a scene change region that includes a scene change in the virtual scene;
determining at least one unit space in the virtual scene that corresponds to the scene change region; and
determining the to-be-updated region based on a boundary region corresponding to each of the at least one unit space in the virtual scene.

4. The method according to claim 3, further comprising:
determining, from the at least one unit space, at least one to-be-deleted unit space in a to-be-updated unit space set, the to-be-updated unit space set including to-be-updated unit spaces that include scene changes;
deleting the at least one to-be-deleted unit space from the at least one unit space; and
updating the to-be-updated unit space set based on the deletion of the at least one to-be-deleted unit space to obtain a target unit space set,
wherein the determining the to-be-updated region comprises:
determining a target to-be-updated unit space from the target unit space set based a specified update time being reached; and
determining, based on a boundary region corresponding to the target to-be-updated unit space, the to-be-updated region that includes the scene change in the virtual scene.

5. The method according to claim 4, wherein the updating the to-be-updated unit space set comprises:
updating, based on the deleted at least one to-be-deleted unit space corresponding to at least one to-be-updated unit space, the at least one to-be-updated unit space with the to-be-updated unit space set, to obtain the target unit space set; and
determining the to-be-updated unit space set as the target unit space set based on the at least one to-be-deleted unit space being all deleted.

6. The method according to claim 4, wherein the determining the target to-be-updated unit space comprises:
determining priority information for each of the to-be-updated unit space in the target unit space set, the priority information indicating at least one of a scene change duration, a virtual object distance, or scene data, the virtual object distance including a distance between the to-be-updated unit space and the virtual object, and the scene data including feature data of the virtual scene;
determining an update priority of each of the to-be-updated unit spaces based on the priority information; and
determining a to-be-updated unit space of the to-be-updated unit spaces with a highest update priority from the target unit space set as the target to-be-updated unit space.

7. The method according to claim 4, further comprising:
determining a space size of each of the at least one unit space in the scene change region; and
determining whether each of the at least one unit space is a valid unit space, the respective unit space being the valid unit space when the space size of the respective unit space is greater than a first specified space size,
wherein the determining, from the at least one unit space, the at least one to-be-deleted unit space comprises:
determining, from the at least one valid unit space corresponding to the at least one unit space, the at least one to-be-deleted unit space in the to-be-updated unit space set.

8. The method according to claim 3, further comprising:
dividing the virtual scene into the plurality of regions based on a second specified space size to obtain a unit space set, the unit space set including unit spaces corresponding to the virtual scene.

9. The method according to claim 3, wherein the determining the to-be-updated region further comprises:
determining the to-be-updated region based on a boundary region corresponding to the scene change region.

10. The method according to claim 1, wherein the generating the to-be-processed mesh data comprises:
performing, when the physical model is a curved surface model, straight surface processing on the curved surface model to obtain a to-be-converted model; and
performing geometrization processing on the to-be-converted model to generate the to-be-processed mesh data.

11. The method according to claim 1, wherein the generating the to-be-processed mesh data comprises:
performing geometrization processing on the physical model to obtain a model vertex set and a geometric figure set corresponding to a specified geometric shape for navigation processing, each geometric figure in the geometric figure set including a vertex index, the vertex index indicating a model vertex in the model vertex set; and
determining the model vertex set and the geometric figure set as the to-be-processed mesh data.

12. The method according to claim 1, wherein the generating the target navigation mesh comprises:
performing voxelization processing on the to-be-processed mesh data to obtain voxel block data and height field data corresponding to each voxel block in the voxel block data;
selecting passable voxel block data from the voxel block data based on the height field data;
performing region generation on the passable voxel block data to obtain a passable region; and
performing surface cutting on the passable region to generate the target navigation mesh.

13. The method according to claim 1, further comprising:
determining the passable route by performing route finding in the to-be-updated region based on the target navigation mesh; and
controlling, based on the passable route, another virtual object to move in the virtual scene.

14. An information processing apparatus, comprising:
processing circuitry configured to:
determine a to-be-updated region that includes a scene change in a virtual scene, the to-be-updated region being one of a plurality of regions in the virtual scene;
obtain a physical model of a virtual object in the to-be-updated region;
generate to-be-processed mesh data of the physical model based on geometric data of the physical model in the to-be-updated region;
generate a target navigation mesh based on the to-be-processed mesh data of the physical model in the to-be-updated region, the target navigation mesh indicating a passable route in the to-be-updated region; and
update a to-be-updated navigation mesh corresponding to the to-be-updated region of the plurality of regions in the virtual scene with the target navigation mesh.

15. The information processing apparatus according to claim 14, wherein the scene change corresponds to one of movement, construction, and removal of the virtual object.

16. The information processing apparatus according to claim 14, wherein the processing circuitry is configured to:
determine a scene change region that includes a scene change in the virtual scene;
determine at least one unit space in the virtual scene that corresponds to the scene change region; and
determine the to-be-updated region based on a boundary region corresponding to each of the at least one unit space in the virtual scene.

17. The information processing apparatus according to claim 16, wherein the processing circuitry is configured to:
determine, from the at least one unit space, at least one to-be-deleted unit space in a to-be-updated unit space set, the to-be-updated unit space set including to-be-updated unit spaces that include scene changes;
delete the at least one to-be-deleted unit space from the at least one unit space;
update the to-be-updated unit space set based on the deletion of the at least one to-be-deleted unit space to obtain a target unit space set;
determine a target to-be-updated unit space from the target unit space set based a specified update time being reached; and
determine, based on a boundary region corresponding to the target to-be-updated unit space, the to-be-updated region that includes the scene change in the virtual scene.

18. The information processing apparatus according to claim 17, wherein the processing circuitry is configured to:
update, based on the deleted at least one to-be-deleted unit space corresponding to at least one to-be-updated unit space, the at least one to-be-updated unit space with the to-be-updated unit space set, to obtain the target unit space set; and
determine the to-be-updated unit space set as the target unit space set based on the at least one to-be-deleted unit space being all deleted.

19. The information processing apparatus according to claim 17, wherein the processing circuitry is configured to:
determine priority information for each of the to-be-updated unit space in the target unit space set, the priority information indicating at least one of a scene change duration, a virtual object distance, or scene data, the virtual object distance including a distance between the to-be-updated unit space and the virtual object, and the scene data including feature data of the virtual scene;
determine an update priority of each of the to-be-updated unit spaces based on the priority information; and
determine a to-be-updated unit space of the to-be-updated unit spaces with a highest update priority from the target unit space set as the target to-be-updated unit space.

20. A non-transitory computer-readable storage medium, storing computer executable instructions which when executed by a processor cause the processor to perform:
determining a to-be-updated region that includes a scene change in a virtual scene, the to-be-updated region being one of a plurality of regions in the virtual scene;
obtaining a physical model of a virtual object in the to-be-updated region;
generating to-be-processed mesh data of the physical model based on geometric data of the physical model in the to-be-updated region;
generating a target navigation mesh based on the to-be-processed mesh data of the physical model in the to-be-updated region, the target navigation mesh indicating a passable route in the to-be-updated region; and
updating a to-be-updated navigation mesh corresponding to the to-be-updated region of the plurality of regions in the virtual scene with the target navigation mesh.
